(19) United States
(12) Patent Application Publication
(10) Pub. No.: US 2019/0135948 A1
(43) Pub. Date: May 9, 2019

(54) PUMPABLE AND/OR FLOWABLE BIOPOLYMER SUSPENSION

(71) Applicant: CARGILL, INCORPORATED, Wayzata, MN (US)

(72) Inventors: Jeffrey J. MALSAM, Exceisior, MN (US); Eric Stanley SUMNER, Minneapolis, MN (US)

(73) Assignee: CARGILL, INCORPORATED, Wayzata, MN (US)

(21) Appl. No.: 16/308,296

(22) PCT Filed: Jun. 9, 2017
(86) PCT No.: PCT/US17/36730

§ 371 Date: Dec. 7, 2018

Related U.S. Application Data
(60) Provisional application No. 62/348,278, filed on Jun. 10, 2016.

(51) Int. Cl. C08B 37/00

(52) U.S. Cl. CPC C08B 37/0024; C09K 8/588; C08B 37/0003

(57) ABSTRACT

Described herein is a pumpable and/or flowable suspension comprising about 10-60 wt % of beta glucan (BG) that when diluted achieves a filterability ratio less than about 1.5. Further described herein is a pumpable and/or flowable suspension comprising about 10-60 wt % of BG wherein greater than 50% of ultimate viscosity can be recovered after running specified dilution procedure for one pass and greater than 70% of ultimate viscosity after two passes.

### TECHNICAL FIELD

The present invention relates to the preparation of a pumpable and/or flowable beta glucan suspension that achieves desired filterability and viscosity build for enhanced oil recovery applications.

### BACKGROUND

Beta glucans are widely used as thickeners in enhanced oil recovery (EOR) applications. Particularly in off-shore applications, there is a desire to utilize such beta glucans, however given the limited amount of real estate it is desirable to receive the beta glucan in solid or suspended form, quickly solubilize or dilute using the water on hand and minimal equipment, wherein the solubilization/dilution procedure provides desirable properties, for example filterability and viscosity, necessary for enhanced oil recovery operations. The major drawback of scleroglucan polymer (a beta glucan) is its poor solubilization. Methods have been investigated and studied in this regard, however each of these methods have presented limitations.

### BRIEF SUMMARY

Described herein is a pumpable and/or flowable suspension comprising about 10-60 wt % of beta glucan (BG) that when diluted, under specified dilution procedure, has a filterability ratio less than about 1.5. Further described herein is a pumpable and/or flowable suspension comprising about 10-60 wt % of BG wherein greater than 50% of ultimate viscosity can be recovered after running a specified dilution procedure for one pass and greater than 70% after two passes.

### DEFINITIONS

“Flowable” is defined as a suspension that retains at least 80% of the beta glucan solids when transferred according to the Transfer Procedure. As described herein, the suspension is pumpable and/or flowable.

“Molecular Weight” is defined as the weight average molecular weight.

“Particle Size Distribution” is defined as the mass-median-diameter of the BG powder.

“Pumpable” is defined as a suspension having a viscosity ranging from 0.1 to 2 million cP at 70° C. measured at 100 s⁻¹ of shear. As described herein, the suspension is pumpable and/or flowable.

“Solid” is defined as a solid (i.e., not a liquid or gas) at standard atmospheric conditions. For the avoidance of doubt, the term “solid” includes powders, pressed or wet cakes, and solids surrounded by an alcohol solution or hydrophobic liquid.

“Suspension” is defined as a stable or unstable, heterogeneous mixture of solid or semi-solid beta glucan particles and a carrier fluid.

“Ultimate Viscosity” is defined as the viscosity measured at a given shear rate after 6 passes through the specified dilution procedure.

### DETAILED DESCRIPTION

Disclosed herein is a pumpable and/or flowable suspension of beta glucan, that when diluted, under a specified dilution procedure, builds viscosity faster than existing commercially available beta glucan materials, provides higher filterability with minimal processing than existing commercially available beta glucan materials, and maintains viscosity throughout filterability testing.

### Beta Glucan Solid Material

The beta glucans (“BG”) described in the present invention include polysaccharides classified as 1,3 beta-D-glucans, i.e., any polysaccharide which has a beta-(1,3)-linked backbone of D-glucose residues, and modifications thereof.

Fungal strains which secrete such glucans are known to those skilled in the art. Examples comprise Schizophyllum commune, Sclerotium rolfsii, Sclerotium glucanicum, Monilinla fructigena, Lentinula edodes or Botrygs cinera. The fungal strains used are preferably Schizophyllum commune or Sclerotium rolfsii.

Examples of such 1,3 beta-D-glucans include curdlan (a homopolymer of beta-(1,3)-linked D-glucose residues produced from, e.g., Agrobacterium spp.), grifolan (a branched beta-(1,3)-D-glucan produced from, e.g., the fungus Grifola frondosa), lentinan (a branched beta-(1,3)-D-glucan having two glucose branches attached at each fifth glucose residue of the beta-(1,3)-backbone produces from, e.g., the fungus Lentinus eeodes), schizophyllan (a branched beta-(1,3)-D-glucan having one glucose branch for every third glucose residue in the beta-(1,3)-backbone produced from, e.g., the fungus Schizophyllan commune), scleroglucan (a branched beta-(1,3)-D-glucan with one out of three glucose molecules of the beta-(1,3)-backbone being linked to a side D-glucose unit by a (1,6)-beta bond produced from, e.g., fungi of the Sclerotium spp.), SSG (a highly branched beta-(1,3)-glucan produced from, e.g., the fungus Sclerotinia sclerotiorum), soluble glucans from yeast (a beta-(1,3)-D-glucan with beta-(1,6)-linked side groups produced from, e.g., Saccharomyces cerevisiae), laminarin (a beta-(1,3)-glucan with beta-(1,3)-glucan and beta-(1,6)-glucan side groups produced from, e.g., the brown algae Laminaria digitata), and cereal glucans such as barley beta glucans (linear beta-(1,3)(1,4)-D-glucan produced from, e.g., Hordeum vulgare, Avena sativa, or Triticum vulgare).

Preferably, 1,3-1,6 beta-D-glucans, i.e., beta glucans comprising a main chain from beta-1,3-glycosidically bonded glucose units and side groups which are formed from glucose units and are beta-1,6-glycosidically bonded thereto, and modifications are used herein. Examples of such beta glucans are scleroglucan and schizophyllan.

### Pumpable And/Or Flowable Beta Glucan Suspension

In accordance with the present invention, solid beta glucan, as described above, may be included in a suspension to obtain a pumpable and/or flowable suspension of beta glucan.

The carrier fluid for the suspension can generally be any fluid that will suspend or partially a dispersion of solid beta glucan material. The beta glucan must not be readily soluble in the carrier fluid or the concentrated suspension may become too viscous (i.e., exceeds 2 million cP at 25° C.). It is also desirable to limit the hydration characteristics of the carrier fluid to limit hydration of the beta glucan being suspended. It shall also be understood that the particle size of the beta glucan will impact viscosity and other properties of the suspension. Accordingly, in creating the suspension, there is a balance between having larger beta glucan particle size (which may aid in the flowability of the suspension) and perhaps selecting a smaller beta glucan particle size (which may aid in solubilization).

It shall be understood that the beta glucan suspension may be amphiphilic, hydrophobic, or hydrophilic. Five preferred types of suspensions are contemplated herein: (1) solid beta glucan material in an immiscible hydrophobic carrier, (2) mixture of solid beta glucan material and alcohol in a hydrophobic carrier, (3) mixture of alcohol, water, and solid beta glucan material in alcohol, (4) solid beta glucan material in a hydrophobic system with reintroduced water, or (5) solid beta glucan material dispersed in an alcohol.

Accordingly, in aspects of the present invention, the carrier fluid can include various alcohols (for example, butanol, heptane, hexane, octanol, pentanol, and isopropyl alcohol), glycols and glycol ethers such as ethylene glycol monobutyl ether (EGMBE), hexylene glycol, 2-methyl hexanol, propylene glycol n-butyl ether, ethylene glycol methyl ether, ethylene glycol ethyl ether, dipropylene glycol methyl ether, dipropylene glycol n-butyl ether, diethylene glycol ethyl ether, propylene glycol, diethylene glycol methyl ether, and the like.

Furthermore, the carrier fluid can include hydrophobic, non-water soluble organic liquids, particularly those having a Log K₀ value ranging from 0.1-10 and more preferably 0.3-8.5, wherein K₀ is the partition coefficient of a hydrophobic material in water. Examples of such hydrophobic liquids may be hydrocarbons such as alkenes (paraffins, isoparaffins) having the molecular formula CₙH₂ₙ₊₂, alkenes (olefins, alpha olefins, polyalphaolefins) having the molecular formula CₙH₂ₙ, various petroleum fractions such as mineral oils, diesel oil, white oils, and the like. Other water insoluble organic liquids which may be useful in this invention are terpenes, vegetable oils, carboxylic esters, malonic esters, sulfonic esters, limonene, alcohols containing 6 to 10 carbon atoms, and the like.

The carrier fluid can be in a single-phase system or a multi-phase system.

In the various aspects of the present invention, the suspension comprises about 10-60 wt % beta glucan, more preferably 20-50 wt %, more preferably 30-40 wt %, more preferably 35-45 wt %, and even more preferably 35-40 wt %. The suspension optionally can comprise one or more suspension, dispersing, or thinning agents and optionally may comprise a biocide.

### Dilution of Suspension

The pumpable and/or flowable beta glucan suspension described herein has desirable properties for EOR applications. When diluted under specified dilution procedure (which is further described below) the beta glucan suspension achieves a filterability ratio less than about 1.5, and more preferably a filterability ratio less than about 1.2.

As to be understood, the specified dilution procedure generally involves dispersing the beta glucan suspension into an aqueous solution and subjecting said resulting solution to relatively high shear. Notably, the equipment and procedures utilized to dilute the beta glucan suspension are suitable for off shore EOR applications and accommodate the limited real estate typically available in off shore EOR applications.

Dilution of the beta glucan suspension can be carried out in either salt water or fresh water. Further, dilution may occur in pH conditions ranging from about 6 to about 8, and in temperature conditions ranging from about 10° C. to 120° C., in preferred aspects from 80° C. to 120° C., and in other preferred aspects from 20° C. to about 40° C. Dilution is achieved via an in-line shear device at a shear rate of 100,000 s−1 to 300,000 s−1. The shear can be applied via many approaches known to one familiar in the art, including moving parts like a rotor-stator pair or a colloidal mixer or static devices like an orifice plate or a narrow tube with high velocity flow. To ensure adequate mixing between the beta glucan suspension and the water source, the dilution can require between 1 and 6 passes through the shear device. Multiple passes, e.g., greater than one pass could be required if viscosity continues to rise, with final dilution occurring after a consistent or slightly dropping viscosity on two consecutive passes.

The beta glucan suspension described herein has a purity sufficient enough that greater than 42%, and in most aspects greater than 50% of ultimate viscosity can be recovered after running the specified dilution procedure for one pass and greater than 70% after two passes. In preferred aspects, greater than 60%, greater than 70%, and even greater than 80% of ultimate viscosity is achieved after running the specified dilution procedure for one pass. In additional preferred aspects, greater than 80%, and even greater than 90% of ultimate viscosity is achieved after running the specified dilution procedure for two passes.

Furthermore, the beta glucan suspension described herein achieves less than 15% viscosity loss during filtration, in preferred aspects has less than 10% viscosity loss, and in more preferred aspects less than 5% viscosity loss during filtration.

### Surfactant Systems

Surfactants have previously been used in EOR applications to enhance overall oil recovery. Accordingly, the pumpable and/or flowable beta glucan suspension described herein may further include a surfactant. In preferred aspects, the surfactant is an anionic surfactant. Anionic surfactants are desirable because of their strong surfactant properties, they are relatively stable, they exhibit relatively low adsorption on reservoir rock, and can be manufactured economically. Typical anionic surfactants are sulfates for low temperature EOR applications and sulfonates, and more specifically sulfonated hydrocarbons, for high temperature EOR applications. Crude oil sulfonates is a product when a crude oil is sulfonated after it's been topped, petroleum sulfonates is a product when an intermediate-molecular-weight refinery stream is sulfonated, and synthetic sulfonates is a product when a relatively purse organic compound is sulfonated. These are all examples of surfactants that may be used herein. Cationic and nonionic surfactants, while not as desirable as anionic surfactants, may also be used primarily as a cosurfactants to improve the behavior of surfactant systems. The surfactant in the pumpable and/or flowable beta glucan suspension described herein may be generated prior to its inclusion into the pumpable and/or flowable beta glucan suspension or alternatively may be generated in situ. It shall also be understand that surfactant floods having a pH ranging from 9-10 are likely more compatible with the pumpable and/or flowable beta glucan suspension described herein.

### MATERIALS & PROCEDURES

It shall be understood that the procedures described herein should be carried out at temperatures ranging from 20-30° C. (except as otherwise noted).

### Specified Dilution Procedure (to Achieve Dilution)

1. Prepare 30 g/1 salt water solution, using deionized water and 59883 Sigma-Aldrich sea salts.
2. Use Pall stainless steel filter funnel (4280) to filter salt water through a 0.8 um EMD Millipore filter (AAWP04700) at 100-300 mL/min.
3. After filtering, check pH of salt water using a properly calibrated pH meter. Adjust to 7.0 using HCl or NaOH if outside of 6.0 to 8.0 pH range. Place salt water solution on a Fisher Scientific Isotemp mixing plate (S88857290) at 800 rpm. Add beta glucan suspension, wherein the beta glucan suspension has at target concentration of 1 g/L of BG, and allow it to stir for 5 minutes. (Note that if concentration at 1 g/L achieves less than 10 cP at 30 rpm after 6 passes, dilution should be rerun such that 10-100 cP is achieved after 6 passes)
4. At 26,000 rpm, feed solution through IKA® Magic Lab® Ultra-Turrax® Inline (UTL) module equipped with the 4M generator set.
5. Measure viscosity after removing air bubbles from solution, for example by letting sample sit or accelerating the separation with a centrifuge or similar device.
6. Continue running for up to 6 passes, or until consecutive passes demonstrate a stable viscosity or a slightly decreasing viscosity.
7. The elapsed time between the beginning of Step 4 and the end of Step 7 of the Specified Dilution Procedure should take between 30 minutes and 2 hours.

### Filtration Procedure

1. Start with a diluted beta glucan suspension according to the Standard Dilution Procedure above. (note: the filtration procedure should be carried out on the resultant solution before microbes begin to form as microbial growth may negatively impact filtration)
2. Assemble Pall stainless steel filter housing (4280) with a 47 mm Millipore AP25 filter

(AP2504700). Close exit of filter housing until ready to start flowing.
3. Pass solution through housing at 100-300 ml/min of flow
4. Assemble Pall stainless steel filter housing (4280) with a 47 mm, 1.2 μm filter, EMD Millipore cellulosic-ester filter (part # RAWP04700), with >200 mL of solution.
5. Place a container on a mass balance for recording mass of material passing through filter.
6. Apply pressure to the filter.
7. Open exit of filter housing and target flux of 1-3 g/s, adjusting pressure as necessary.
8. Once flow is established, maintain constant pressure during filtration testing.
9. Record time to flow 60 g, 80 g, 160 g, and 180 g of solution through the filter using the balance.
10. Calculate filterability ratio using the filterability ratio equation:

$$\frac{Time ( 180 g ) - Time ( 160 g )}{Time ( 80 g ) - Time ( 60 g )}$$

11. The elapsed time between the beginning of Step 4 of the Standard Dilution Procedure and the end of Step 9 of the Filtration Procedure should take between 30 minutes and 4 hours.

### Viscosity Measurement

The following viscometer was used on the experiment to test viscosity.
1. Viscosity measurements were done on degassed samples using a Brookfield Ametek® LVT (spindle 1, 12, 30, and 60 rpm) viscometer, referenced as LVT.

### Transfer Procedure

1. Agitate suspension with an IKA® Eurostar Power Control-Visc (PWR CV 51) set to a RPM ranging from 500-2000 RPM with an IKA® R 1381 3-bladed impeller.
2. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation.
3. Turn the pump on to a setting of 7 and transfer approximately 135 grams of solution, stopping as soon as liquid drops below the bottom of the agitator but still covers the tubing inlet. Measure the mass of solution.
4. Weigh and put a Whatman® #4 125mm filter paper into a Coors® 60246 Buchner funnel under 4″ H₂O vacuum such that filtrate is pulled into the collection flask. Pass some of the carrier fluid through the filter to wet the paper. Pour the transferred solution into the Buchner funnel and continue to pull vacuum until no more filtrate flow is observed.
5. Over 30 seconds uniformly rinse the cake with solvent while manually agitating the cake with a spatula while avoiding disturbing the filter. Stop once filtrate flow ceases and a wet cake is clearly formed.
6. Recover the wet cake and filter paper and put into a 20 mmHg vacuum oven at 150 C for drying. After two hours, transfer cake to an atmospheric oven at 150 C for 14 to 20 hours. Remove the filter cake from the oven and weigh the dry cake and filter paper.
7. For the dried transferred solution calculate the mass concentration of solids to compare against initial solution.
8. Calculations are done by comparing mass of solids to the mass of solution: (mass of dry cake+paper−mass of dry paper)/(mass of solution).

### EXAMPLES

### Example 1: Production of Beta Glucan Material (Scleroglucan) Described Herein

Using a 5000 liter jacketed vessel with moderate agitation, 7 g/L of commercial Actigum CS6 from Cargill is added to 2400 liters of 11.8° C. water and mixed for 1 hour. After an hour of mixing, the vessel is heated to 85° C. and left under agitation for 12 hours without temperature control. After 12 hours the temperature is 41.3° C. and the vessel is reheated to 80° C. and passed through a Guerin homogenizer (ALM6; Series B 8250 30 000; Year 1998) at 200 bar of pressure and 300 l/hr.

The homogenized mixture is cooled to 50° C. 4 g/L of CaCl₂*2H₂O was added. pH is reduced to 1.81 using 20% HCl. This mixture is agitated for 30 minutes to enable precipitation of oxalic acid.

After maturation, the solution is adjusted back to 5.62 pH using 10% Na₂CO₃ and heated to 85° C. and left under agitation without temperature control for 14 hours the reheated to 80° C.

After reaching 80° C. 20 g/L of Dicalite 4158 filter aid is added to the vessel and mixed for 10 minutes.

After mixing, the solution is fed to a clean Choquenet 12 m² press filter with Sefar Fyltris 25080 AM filter clothes at 1400 L/hr recycling the product back to the feed tank for 10 minutes. At the end of recycle, the flow is adjusted to 1300 L/hr and passed through the filter. Once the tank is empty an additional 50 liters of water is pushed into the filter. The fluid from this water flush and a 12 bar compression of the cake is both added to the collected permeate. The filter is cleaned after use.

The filtered permeate, water flush, and compression fluid is agitated and heated back to 80° C.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1400 L/hr.

Without cleaning the filter, 5.33 g/L of Clarcel® DICS and 6.667 g/L of Clarcel® CBL is added to the mixture and agitated for one hour while maintaining temperature at 80° C. This mixture is then recycled through the Dicalite coated Choquenet 12 m² press filter with Sefar Fyltris 25080 AM filter clothes at 1400 L/hr for 15 minutes. After the recycle, the tank is passed through the filter at 1350 L/hr. An additional 50 liters of flush water is pushed through the filter and collected as permeate as well. Compression fluid from the filter is not captured.

This twice filtered material is heated to 85° C. and left agitated without temperature control for 14 hours. At this point the material is reheated to 80° C. for a third filtration step.

The heated mixture has 6 kg of Dicalite 4158 added and mixed for 10 minutes. At 1400 L/hr this solution is recycled through a clean Choquenet 12 m² press filter with Sefar Fyltris 25080 AM filter clothes at 1400 L/hr for 15 minutes. After the recycle, the tank is passed through the filter at 1450 L/hr.

Without cleaning the filter, 5.33 g/L of Clarcel® DICS and 6.667 g/L of Clarcel® CBL is added to the mixture and agitated for one hour while maintaining temperature at 80° C. This mixture is then recycled through the Dicalite coated Choquenet 12 m² press filter with Sefar Fyltris 25080 AM filter clothes at 1600 L/hr for 15 minutes. After the recycle, the tank is passed through the filter at 1700 L/hr. An additional 50 liters of flush water is pushed through the filter and collected as permeate as well. Compression fluid from the filter is not captured.

The triple filtered permeate is cooled to 60° C. and mixed with 83% IPA at a 1:2 ratio, 2 g IPA solution for each g of scleroglucan solution. This precipitates scleroglucan fibers which can be mechanical separated from the bulk solution. In this example, a tromel separator is used to partition the precipitated fibers from the bulk liquid solution.

After recovery of the fibers they are washed with another 0.5 g 83% IPA solution for each 1 g of initial triple filtered permeate scleroglucan solution.

Wash fibers are dried in an ECI dryer (Volume 100 litres; Type 911-10; Year 1987) with 95° C. hot water for 1 hour and 13 minutes to produce a product with 89.3% dry matter. This material is ground up and sieved to provide powder smaller in size than 250 micron. This final ground scleroglucan material is the beta glucan material described herein and is used in some of the examples.

### Example 2: 20% BG Suspension in Mineral Oil

A mineral oil suspension was made blending the beta glucan from example 1 and mineral oil (Sigma Aldrich M1180-4L). Mass measurements of both components were made and samples were manually stirred into a beaker to have 20% BG solids and 80% mineral oil.

Using the dilution procedure, put 1 gram per liter (g/L) BG or 5 g/L of suspension in solution. The suspension was stirred before measuring to ensure uniform distribution. After mixing, add solution to IKA® Magic Lab® in UTL configuration with a 4M rotor stator pair running unit at 26,000 rpm. Measure viscosity using LVT viscometer. Repeat processing through Magic Lab, measuring viscosity with LVT viscometer each pass for a total of 6 passes. Table 1 provides the results of the viscosity build, where viscosity build is average of measured viscosity divided by the viscosity after 6 passes through the unit.

The filterability ratio of the 6 pass material was 1.32.

TABLE 1

| | | Viscosity | Viscosity | Viscosity |
|---|---|---|---|---|
| | | Build | Build | Build |
| | | Measured | Measured | Measured |
| | Average | on | on | on |
| | Viscosity | Brookfield | Brookfield | Brookfield |
| Pass | Build | @12 rpm | @30 rpm | @60 rpm |
| 1 | 88% | 93% | 87% | 86% |
| 2 | 113% | 122% | 112% | 105% |
| 3 | 106% | 111% | 106% | 103% |
| 4 | 104% | 107% | 102% | 101% |
| 5 | 102% | 104% | 102% | 100% |
| 6 | 100% | 100% | 100% | 100% |
| After | 102% | 107% | 100% | 97% |
| Filtration | | | | |

### Example 3: 40% BG Suspension in Mineral Oil

A mineral oil suspension was made blending the beta glucan from example 1 and mineral oil (Sigma Aldrich M1180-4L). Mass measurements of both components were made and samples were manually stirred into a beaker to have 40% BG solids and 60% mineral oil.

Using the solubilization procedure, put 1 gram per liter (g/L) BG or 2.5 g/L of suspension in solution. The suspension was stirred before measuring to ensure uniform distribution. After mixing, add solution to IKA® Magic Lab® in UTL configuration with a 4M rotor stator pair running unit at 26,000 rpm. Measure viscosity using LVT viscometer. Repeat processing through Magic Lab, measuring viscosity with LVT viscometer each pass for a total of 6 passes. Table 2 provides the results of the viscosity build, where viscosity build is average of measured viscosity divided by the viscosity after 6 passes through the unit.

The filterability ratio of the 6 pass material was 1.12.

TABLE 2

| | | Viscosity | Viscosity | Viscosity |
|---|---|---|---|---|
| | | Build | Build | Build |
| | Average | Measured on | Measured on | Measured on |
| | Viscosity | Brookfield | Brookfield | Brookfield |
| Pass | Build | @12 rpm | @30 rpm | @60 rpm |
| 1 | 76% | 75% | 75% | 77% |
| 2 | 109% | 114% | 108% | 104% |
| 3 | 108% | 112% | 107% | 104% |
| 4 | 104% | 105% | 104% | 102% |
| 5 | 102% | 102% | 102% | 103% |
| 6 | 100% | 100% | 100% | 100% |
| After | 96% | 96% | 96% | 97% |
| Filtration | | | | |

### Example 4: 35% BG Suspension in 90% n-Butanol/10% Water

Prepare a suspension using material from Example 3, n-Butanol, and water. Place 2.7 grams of a mixture of 90% butanol and 10% water by mass are put into an ASTM-E960 low form 20 mL beaker. Add 1.44 grams of BG to beaker and stir to create a 35% suspension.

Using the dilution procedure, measure out 2 g/kg NaCl to put the entire suspension in solution at a concentration of 1 g/L of the BG. After dumping material, use a pipette to rinse any residual suspension from the stir rod and beaker to ensure the entire mass of BG is used. After mixing, add solution to IKA® Magic Lab® in UTL configuration with a 4M rotor stator pair running unit at 16,000 rpm. After each pass centrifuge solution and measure viscosity on Brookfield LVT. Repeat processing through Magic Lab and sampling for viscosity for the first 3 passes and the 6^{th}, 9^{th}, and 12th pass. Table 3 provides the results of the viscosity build. Ultimate viscosity is achieved after 6 passes.

Based on rotor geometry and 10,000 rpm the system shear is around 105,000 s⁻¹.

TABLE 3
Ultimate Viscosity determination

| Solution | 6 RPM | 12 RPM | 30 RPM | 60 RPM |
|---|---|---|---|---|
| 1st pass | 125% | 110% | 98% | 97% |
| 2nd pass | 131% | 110% | 100% | 101% |
| 3rd pass | 119% | 110% | 103% | 101% |
| 6th pass | 100% | 100% | 100% | 100% |
| (Ultimate) | | | | |
| 9th pass | 106% | 100% | 95% | 100% |
| 12th pass | 88% | 90% | 97% | 99% |
| After | 106% | 97% | 98% | 99% |
| Filtration | | | | |

Filterability of material after 12 passes using the filterability procedure was 1.15.

### Example 5: Flowability of 35% Actigum® CS11 in n-Heptane

In a 600 mL low form ASTM E960 beaker, add 61.3g of Actigum® CS11 to 113.8 g of n-Heptane, a 35% solution (Note: Actigum® CS11 was used because of limited beta glucan material available made according to Example 1 and because CS11's flowability performance is substantially similar to the beta glucan material made according to Example 1 and described and claimed herein. This is the case for all Examples herein utilizing Actigum® CS11). Agitate the solution with an IKA® Eurostar Power Control-Visc (PWR CV S1) set to 658 RPM with an IKA® R 1381 3-bladed impeller. Mount the bottom of the impeller blade in the middle of the beaker 8.5 mm above the bottom. Connect the middle of a 50″ Masterflex0 Tygon LFL 0.25″ diameter tubing to a Masterflex0 Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (n-heptane) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 80 C for drying. After two hours, remove the filter cake from the oven. Weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 149.1 grams

Filter paper: 0.9 grams

Dried transferred solution+paper: 51.1 grams

Recovered mass fraction: 34%

The measured solids fraction of the transferred solution is 34% and in the initial solution is 35%. This is a measured recovery of 97%.

### Example 6: Flowability of 35% Actigum® CS11 in n-Hexane

In a 600 mL low form ASTM E960 beaker, add 61.3 g of CS 11 to 113.8 g of n-Hexane, a 35% solution. Agitate the solution with an IKA® Eurostar Power Control-Visc (PWR CV S1) set to 658 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (n-hexane) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 80 C for drying. After two hours, remove the filter cake from the oven. Weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 146.9 grams

Filter paper: 0.9 grams

Dried transferred solution +paper: 51.6 grams

Recovered mass fraction: 35%

The measured solids fraction of the transferred solution is 35% and in the initial solution is 35%. This is a measured recovery of 100%.

### Example 7: Flowability of 35% Actigum® CS11 in n-Octanol

In a 600 mL low form ASTM E960 beaker, add 61.3 g of CS11 to 113.9 g of n-Octanol, a 35% solution. Agitate the solution with an IKA® Eurostar Power Control-Visc (PWR CV S1) set to 610 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125mm filter paper into a Coors® 60246 Buchner funnel under 4″ H2O vacuum such that filtrate is pulled into the collection flask. Pass some of the solvent (n-octanol) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 135 grams

Filter paper: 0.9 grams

Dried transferred solution+paper: 44.3 grams

Recovered mass fraction: 32% The measured solids fraction of the transferred solution is 32% and in the initial solution is 35%. This is a measured recovery of 91%.

### Example 8: Flowability of 35% Actigum® CS11 in n-Pentanol

In a 600 mL low form ASTM E960 beaker, add 61.3 g of CS11 to 113.9 g of n-pentanol, a 35% solution. Agitate the solution with an IKA® Eurostar Power Control-Visc (PWR CV S1) set to 610 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125mm filter paper into a Coors® 60246 Buchner funnel under 4″ H2O vacuum such that filtrate is pulled into the collection flask. Pass some of the solvent (n-pentanol) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 137.1 grams

Filter paper: 0.9 grams

Dried transferred solution+paper: 45.5 grams

Recovered mass fraction: 33%

The measured solids fraction of the transferred solution is 33% and in the initial solution is 35%. This is a measured recovery of 94%.

### Example 9: Flowability of 35% Actigum® CS11 in Isopropyl Alcohol

In a 600 mL low form ASTM E960 beaker, add 61.3 g of CS11 to 113.8 g of isopropyl alcohol, a 35% solution. Agitate the solution with an IKA® Eurostar Power Control-Visc (PWR CV S1) set to 531 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125mm filter paper into a Coors® 60246 Buchner funnel under 4″ H2O vacuum such that filtrate is pulled into the collection flask. Pass some of the solvent (isopropyl alcohol) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 137.6 grams

Filter paper: 0.9 grams

Dried transferred solution+paper: 45.1 grams

Recovered mass fraction: 32%

The measured solids fraction of the transferred solution is 32% and in the initial solution is 35%. This is a measured recovery of 91%.

### Example 10: Flowability of 35% Actigum® CS11 in n-Butanol

In a 600 mL low form ASTM E960 beaker, add 61.3g of CS11 to 113.9g of n-butanol, a 35% solution. Agitate the solution with an IKA® Eurostar Power Control-Visc (PWR CV S1) set to 655 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (n-butanol) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 135.2 grams

Filter paper: 0.9 grams

Dried transferred solution+paper: 45.6 grams

Recovered mass fraction: 33%

The measured solids fraction of the transferred solution is 33% and in the initial solution is 35%. This is a measured recovery of 94%.

### Example 11: Flowability of 35% Actigum® CS11 in Mineral Oil

In a 600 mL low form ASTM E960 beaker, add 61.3 g of CS11 to 113.8 g of Sigma-Aldrich® M1180 mineral oil, a 35% solution. Agitate the solution with an IKA® Eurostar Power Control-Visc (PWR CV S1) set to 951 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125mm filter paper into a Coors® 60246 Buchner funnel under 4″ H2O vacuum such that filtrate is pulled into the collection flask. Pass some n-heptane solvent through the filter to wet the paper. Pour the transferred solution into the Buchner funnel and continue to pull vacuum until no more filtrate flow is observed. Over 30 seconds uniformly rinse the cake with 100 mL of n-heptane solvent to pass mineral oil through the filter paper. Stop once filtrate flow ceases and a wet cake is clearly formed. Recover the wet cake and filter paper and put into a 20 mmHg vacuum oven at 150 C for drying. After two hours, transfer cake to an atmospheric oven at 150 C for 14 to 20 hours. Remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)(mass of solution).

The measured masses are:

Transferred solution: 129.6 grams

Filter paper: 0.9 grams

Dried transferred solution+paper: 41.6 grams

Recovered mass fraction: 31%

The measured solids fraction of the transferred solution is 31% and in the initial solution is 35%. This is a measured recovery of 88%.

### Example 12: Flowability of 35% Actigum® CS11 in Tween® 20

In a 600 mL low form ASTM E960 beaker, add 61.3 g of CS11 to 113.9 g of Tween® 20, a 35% solution. Agitate the solution with an IKA® Eurostar Power Control-Visc (PWR CV S1) set to 733 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some n-heptane solvent through the filter to wet the paper. Pour the transferred solution into the Buchner funnel and continue to pull vacuum until no more filtrate flow is observed. Over 30 seconds uniformly rinse the cake with 5 mL of heptane and 100 mL of n-pentanol solvent while manually agitating the cake with a spatula while avoiding disturbing the filter to pass tweenthrough the filter paper. Stop once filtrate flow ceases and a wet cake is clearly formed. Recover the wet cake and filter paper and put into a 20 mmHg vacuum oven at 150 C for drying. After two hours, transfer cake to an atmospheric oven at 150 C for 14 to 20 hours. Remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 106 grams

Filter paper: 0.9 grams

Dried transferred solution+paper: 32.8 grams

Recovered mass fraction: 30%

The measured solids fraction of the transferred solution is 30% and in the initial solution is 35%. This is a measured recovery of 85%.

### Example 13: Flowability of 35% Actigum® CS11 in Dipropylene Glycol Methyl Ether

In a 600 mL low form ASTM E960 beaker, add 61.3 g of CS11 to 113.8 g of Sigma-Aldrich® 283282 dipropylene glycol monomethyl ether (DPGME), a 35% solution.

Agitate the solution with an IKA® Eurostar Power Control-Visc (PWR CV S1) set to 693 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125mm filter paper into a Coors® 60246 Buchner funnel under 4″ H2O vacuum such that filtrate is pulled into the collection flask. Pass some n-heptane solvent through the filter to wet the paper. Pour the transferred solution into the Buchner funnel and continue to pull vacuum until no more filtrate flow is observed. Over 30 seconds uniformly rinse the cake with 100 mL of n-heptane solvent to clear high boiling point DPGME through the filter paper. Stop once filtrate flow ceases and a wet cake is clearly formed. Recover the wet cake and filter paper and put into a 20 mmHg vacuum oven at 150 C for drying. After two hours, transfer cake to an atmospheric oven at 150 C for between 14 to 20 hours. Remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 137.1 grams

Filter paper: 0.9 grams

Dried transferred solution+paper: 44.3 grams

Recovered mass fraction: 32%

The measured solids fraction of the transferred solution is 32% and in the initial solution is 35%. This is a measured recovery of 91%.

### Example 14: Flowability of 65% Actigum® CS11 in n-Heptane

In a 600 mL low form ASTM E960 beaker, add 113.8 g of CS11 to 61.3g of n-heptane, a 65% solution. Agitate the solution with an IKA® Eurostar Power Control-Visc (PWR CV S1) set to 951 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and attempt to transfer approximately 135 grams of solution, stopping as soon as liquid drops below the bottom of the agitator but still covers the tubing inlet.

Due to the high level of solids in the solution, the pump was unable to transfer the solution to the other beaker, plugging after only a small amount of solution was pumped.

### Example 15: Flowability of 55% Actigum® CS11 in n-Heptane

In a 600 mL low form ASTM E960 beaker, add 96.3 g of CS11 to 78.8 g of n-heptane, a 55% solution. Agitate the solution with an IKA® Eurostar Power Control-Visc (PWR CV S1) set to 950 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (n-heptane) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 103.7 grams

Filter paper: 0.9 grams

Dried transferred solution+paper: 50.2 grams

Recovered mass fraction: 48%

The measured solids fraction of the transferred solution is 48% and in the initial solution is 55%. This is a measured recovery of 87%.

### Example 16: Flowability of 45% Actigum® CS11 in n-Butanol

In a 600 mL low form ASTM E960 beaker, add 78.8 g of CS11 to 96.4 g of n-butanol, a 45% solution. Agitate the solution with an IKA® Eurostar Power Control-Visc (PWR CV S1) set to 804 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125mm filter paper into a Coors® 60246 Buchner funnel under 4″ H2O vacuum such that filtrate is pulled into the collection flask. Pass some of the solvent (n-butanol) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 138.1 grams

Filter paper: 0.9 grams

Dried transferred solution+paper: 55.8 grams

Recovered mass fraction: 40%

The measured solids fraction of the transferred solution is 40% and in the initial solution is 45%. This is a measured recovery of 88.9%.

### Example 17: Flowability of 40% Actigum® CS11 in n-Butanol

In a 600 mL low form ASTM E960 beaker, add 70 g of CS11 to 105 g of n-butanol, a 40% solution. Agitate the solution with an IKA® Eurostar Power Control-Visc (PWR CV S1) set to 654 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (n-butanol) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 148 grams

Filter paper: 0.9 grams

Dried transferred solution+paper: 55.4 grams

Recovered mass fraction: 37%

The measured solids fraction of the transferred solution is 37% and in the initial solution is 40%. This is a measured recovery of 92.5%.

### Example 18: Flowability of 35% Actigum® CS11 in 90% n-Butanol and 10% H2O

In a 600 mL low form ASTM E960 beaker, add 61.3 g of CS11 to 113.8 g of 90% n-butanol and 10% water solvent, a 35% solution. Agitate the solution with an IKA® Eurostar Power Control-Visc (PWR CV S1) set to 633 RPM with an IKA® R 1381 3-bladed impeller. Mount the bottom of the impeller blade in the middle of the beaker 8.5 mm above the bottom.

Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (90% n-butanol/10% water) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 125.1 grams

Filter paper: 0.9 grams

Dried transferred solution+paper: 40.5 grams

Recovered mass fraction: 32%

The measured solids fraction of the transferred solution is 32% and in the initial solution is 35%. This is a measured recovery of 91%.

### Example 19: Flowability of 30% Beta Glucan as Described in Example 1 in 90% n-Butanol and 10% H2O

In a 600 mL low form ASTM E960 beaker, add 70 g of scleroglucan as described in Example 1 to 105 g of 90% n-butanol and 10% water solvent, a 35% solution. Agitate the solution with an IKA® Eurostar Power Control-Visc (PWR CV 51) set to 1979 RPM with an IKA® R 1381 3-bladed impeller. Mount the bottom of the impeller blade in the middle of the beaker 8.5 mm above the bottom. Connect the middle of a 50″ Masterflex® Tygon LFL 0.25″ diameter tubing to a Masterflex® Variable-Speed Drive model EW-07559-00 pump. Place one end of the tube in the suspension above the base of the beaker and just below the bottom of the agitator and the other in a second empty 600 mL beaker such that the two beakers are level and on the same elevation. Turn the pump on to a setting of 7 and transfer approximately 135 grams of solution, stopping as soon as liquid drops below the bottom of the agitator but still covers the tubing inlet. Measure the mass of solution.

Weigh and put a Whatman® #4 125 mm filter paper into a Coors® 60246 Buchner funnel under 4″ H2O vacuum such that filtrate is pulled into the collection flask. Pass some of the solvent (90% n-butanol and 10% H2O) through the filter to wet the paper. Pour the transferred solution into the Buchner funnel and continue to pull vacuum until no more filtrate flow is observed, wet cake is clearly formed. Recover the wet cake and filter paper and put into a 20 mmHg vacuum oven at 150 C for drying. After two hours, remove the filter cake from the oven and weigh the dry cake and filter paper.

For the dried transferred solution calculate the mass concentration of solids to compare against initial solution. Calculations are done by comparing mass of solids to the mass of solution: (mass of dry cake+paper−mass of dry paper)/(mass of solution).

The measured masses are:

Transferred solution: 130.9 grams

Filter paper: 0.9 grams

Dried transferred solution+paper: 37.3 grams

Recovered mass fraction: 28%

The measured solids fraction of the transferred solution is 28% and in the initial solution is 30%. This is a measured recovery of 93%.

What is claimed is:

1. A suspension comprising about 10-60 wt % of beta glucan (BG), that when diluted achieves a filterability ratio less than about 1.5.

2. (canceled)

3. The suspension of claim 1, wherein the BG is 1,3-1,6 beta glucan.

4-6. (canceled)

7. The suspension of claim 1, wherein the filterability ratio is less than about 1.2.

8. The suspension of claim 1, wherein the viscosity of the suspension ranges from 0.1 to 2 million cP at 70° C. measured at 100 s⁻¹ of shear.

9. The suspension of claim 1, wherein the BG is suspended in alcohol.

10. The suspension of claim 1, wherein the BG is suspended in a hydrophobic fluid.

11. The suspension of claim 1, wherein the BG is suspended in a hydrophilic fluid.

12. The suspension of claim 1, wherein the BG is suspended in an amphiphilic fluid.

13. The suspension of claim 1, wherein dilution is carried out at a shear rate of 40,000 s−1 to 300,000 s−1.

14-18. (canceled)

19. A suspension comprising about 10-60 wt % of beta glucan (BG) wherein greater than 50% of ultimate viscosity can be recovered after running specified dilution procedure for one pass and greater than 70% of ultimate viscosity after two passes.

20. The suspension of claim 19, wherein greater than 60% of ultimate viscosity can be recovered after one pass.

21. The suspension of claim 19, wherein greater than 70% of ultimate viscosity can be recovered after running specified dilution procedure for one pass.

22. The suspension of claim 19, wherein greater than 80% of ultimate viscosity can be recovered after running specified dilution procedure for one pass.

23. The suspension of claim 19, wherein greater than 80% of ultimate viscosity can be recovered after running specified dilution procedure for two passes.

24. The suspension of claim 19, wherein greater than 90% of ultimate viscosity can be recovered after running specified dilution procedure for two passes.

25. The suspension of claim 19, wherein the filterability ratio of the diluted suspension is less than about 1.2.

26. (canceled)

27. The suspension of claim 19 wherein the BG is 1,3-1,6 beta glucan.

28-30. (canceled)

31. The suspension of claim 19, wherein dilution is carried out at a shear rate of 40,000 s−1 to 300,000 s−1.

32-36. (canceled)

37. A suspension comprising about 10-60 wt % of beta glucan (BG) that when diluted achieves less than 10% viscosity loss during filtration.

38. (canceled)

39. The suspension of claim 37 wherein the BG is 1,3-1,6 beta glucan.

40-43. (canceled)
